(19) United States
(12) Patent Application Publication
(10) Pub. No.: US 2026/0370785 A1
(43) Pub. Date: Nov. 19, 2026

(54) PIPELINE INSPECTION DEVICE WITH USER INTERFACE

(71) Applicant: MILWAUKEE ELECTRIC TOOL CORPORATION, Brookfield, WI (US)

(72) Inventors: Lucas Bogdan, West Allis, WI (US); Daniel W. Ruppert, Brookfield, WI (US); Francisco J. Hernandez, Brookfield, WI (US); Tyler A. Wahl, Brookfield, WI (US)

(21) Appl. No.: 19/648,858

(22) Filed: Apr. 15, 2026

Related U.S. Application Data
(60) Provisional application No. 63/789,226, filed on Apr. 15, 2025.

(51) Int. Cl. H04N 7/18; G06F 3/01; G06F 3/04817; G06F 3/0488; H04N 7/10; H04N 23/50

(52) U.S. Cl. CPC H04N 7/183; G06F 3/016; G06F 3/04817; G06F 3/0488; H04N 7/10; H04N 23/555; G06F 2203/04804

(57) ABSTRACT

An inspection system includes a cable with an image capture device positioned at a distal end of the cable, wherein the image capture device is configured to output digital data. The inspection system further includes a monitoring device configured to receive the digital data from the image capture device. The monitoring device includes a housing with a removable first handle and a removable second handle, a display supported by the housing and configured to display images captured by the image capture device, a user interface on the display, and a haptic feedback device configured to provide haptic feedback in response to a user interaction. The haptic feedback device may be an exciter configured to induce vibration in the display during touchscreen interactions. The user interface includes a plurality of touchscreen icons, each having an opacity that permits an underlying image to remain visible behind the user interface.

### CROSS-REFERENCE TO RELATED APPLICATIONS

This application claims priority to and the benefit of U.S. Provisional Patent Application Serial No. 63/789,226, filed Apr. 15, 2025, the entire contents of which are incorporated herein.

### FIELD OF THE INVENTION

The present invention relates to inspection devices for inspecting sewers, drains, pipes, or other conduits, and to user interfaces for the inspection devices.

### SUMMARY

In one aspect, the disclosure provides an inspection system comprising a cable including an image capture device positioned at a distal end of the cable, wherein the image capture device is configured to output digital data. The inspection system further comprises a monitoring device configured to receive the digital data from the image capture device. The monitoring device includes a housing including a removable first handle and a removable second handle, a display supported by the housing and configured to display images captured by the image capture device in response to receiving the digital data, a user interface on the display, and a haptic feedback device configured to provide haptic feedback in response to a user interaction with the user interface.

In another aspect, the disclosure provides a display device for use with a pipeline inspection system. The display device comprises a housing including a removable first handle and a removable second handle, a display supported by the housing and configured to display images captured by an image capture device of the pipeline inspection system, a user interface on the display, and a haptic feedback device positioned within the housing and spaced a distance from the display. The haptic feedback device is configured to provide haptic feedback in response to a user interaction with the user interface.

In another aspect, the disclosure provides a method of inspecting a pipeline. The method comprises capturing images of an interior of the pipeline with an image capture device positioned at a distal end of a cable, transmitting digital data corresponding to the captured images from the image capture device to a monitoring device, displaying the captured images on a display of the monitoring device, receiving user input via a user interface on the display, and providing haptic feedback via a haptic feedback device in response to the user input.

Before any embodiments are explained in detail, it is to be understood that the embodiments are not limited in application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”).

As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors.

Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 is an illustration of a pipeline inspection device, according to some aspects and examples.

FIG. 2 is a detailed illustration of a display device for use with the pipeline inspection device of FIG. 1, according to some aspects and examples.

FIG. 3 is a detailed illustration of a display device for use with the pipeline inspection device of FIG. 1, according to some aspects and examples.

FIG. 4 is a detailed illustration of a display for use with the display device of FIG. 3, according to some aspects and examples.

FIG. 5 is a schematic of an inside of the display device of FIG. 3, according to some aspects and examples.

FIG. 6 is a flowchart illustrating a method of inspecting a pipeline, according to some aspects and examples.

### DETAILED DESCRIPTION

Before any embodiments are explained in detail, it is to be understood that embodiments are not limited in their application to the details of construction and the arrangement of components set forth in the following description or illustrated in the following drawings. Other embodiments are possible and embodiments described and illustrated are capable of being practiced or of being carried out in various ways. A pipeline inspection device is an apparatus that inspects the interior of pipelines to identify any damages or defects. The device may include image capture devices, cameras, sensors, navigation systems, data storage, and communication systems. The image capture device may capture images of the inside of the pipe, while sensors collect data about the conditions within. Navigation systems help the device operator track the device's location, and data storage allows the operator to review and analyze the data. Communication systems enable the device to transmit data to a control center or remote operator. Examples and embodiments described herein relate to display devices for use with a pipeline inspection device. In some examples, the display device may be useable with a borescope to allow for captured images to be displayed thereon. Additionally or alternatively, the display device may directly attach to a borescope camera. In some instances, the display device is directly coupled to an image capture device, allowing an operator to use the display device to examine an area.

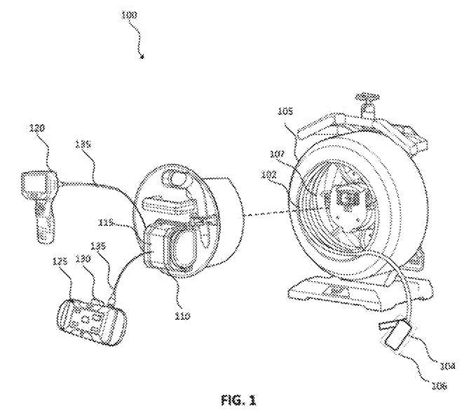

FIG. 1 illustrates a pipeline inspection device 100 including a reel housing 105 and a push cable 102 with an image capture device 104, also referred to as a camera, connected to the push cable 102. In some examples, the push cable 102 may be referred to as an inspection cable. The push cable 102 is stored on a reel 107 within the reel housing 105 such that that the push cable 102 may be wound and unwound (i.e., spooled and unspooled) as needed by an operator of the pipeline inspection device 100. In some instances, the image capture device 104 is detachably connected to the push cable 102, such that multiple image capture devices may be interchangeably connected and disconnected from the push cable 102.

The pipeline inspection device 100 also includes a hub 110. The hub 110 includes a battery receptacle that selectively receives a battery pack (e.g., a power tool battery pack) to power the pipeline inspection device 100. The hub 110 also includes electronics, such as an image processor and/or a wireless transceiver, to control operation of the pipeline inspection device 100. The hub 110 is configured to connect to a display, such as a tablet, smartphone, laptop, or similar device configured to display images captured by the image capture device 104. The pipeline inspection device 100 also includes an input/output interface 115 configured to electrically communicate with handheld devices, such as image capture device 104, a handheld controller 120, and a monitor, also referred to as display device 125. However, in other examples, the handheld controller 120 may be coupled directly to the image capture device 104 via the push cable 102. In some instances, the handheld devices are battery powered. For example, handheld controller 120 and/or the display device 125 may be powered by a detachable, rechargeable battery pack 130. In other instances, display device 125 connects to the input/output interface 115 by way of a cable 135, where the cable is configured to provide power and enable communication between the display device 125 and the pipeline inspection device 100. For example, the cable 135 may include a USB-C connector to enable electrical communication between the connected devices. In other instances, display device 125 connects to the pipeline inspection device 100 wirelessly via a near field communication (NFC) connection, a short-range wireless connection (for example, a Bluetooth® connection), an IEEE 802.11 protocol connection (for example, Wi-Fi), or the like.

In some instances, the image capture device 104 includes a removable cover 106 (referred to as cover 106) configured to protect the image capture device 104. The cover 106 is configured to protect the image capture device 104 as it passes through a pipe. For example, old pipes often require a relining procedure that includes releasing a resin within the pipe and solidifying the resin with a UV light. During this process, the resin may coat the lens of an uncovered image capture device, thereby damaging or destroying the image capture device. However, by including a removable and disposable cover 106, the image capture device 104 may be protected from damage during use.

In some examples, the cover 106 is molded out of polycarbonate and may include two pieces joined together to enclose and cover the image capture device 104. In other examples, a silicone tube or sleeve is provided together or as separate piece from the cover 106, where the silicone tube additionally covers a portion of the cable used for relining pipes. In some examples, the cover 106 may be configured to be disposable. However, in other examples, the cover may be configured to be reusable.

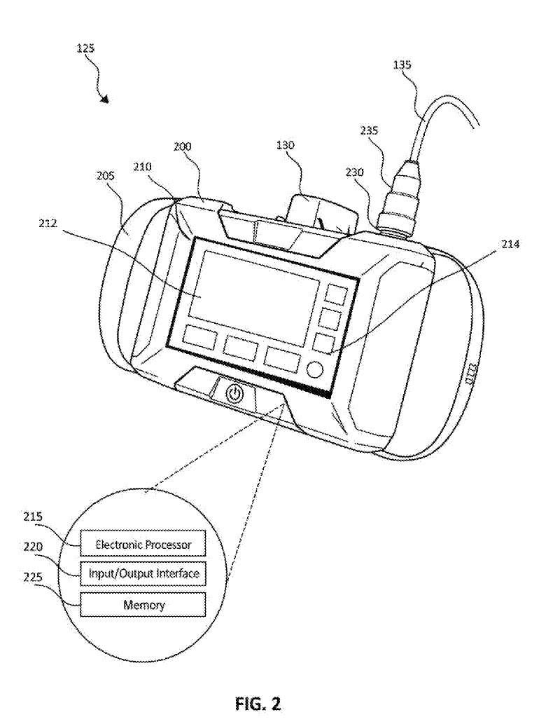

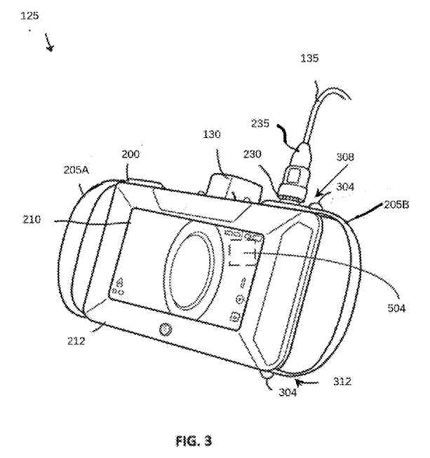

FIGS. 2 and 3 are illustrations of the display device 125 described above, according to some aspects and examples. The display device 125 may also be called a borescope or part of a borescope. The display device 125 includes a housing 200. The display device 125 also includes a display 210 for viewing an image or video 240 captured by the image capture device 104. The display 210 also includes a user interface 212 for controlling an image capture device, such as image capture device 104, configuring a setting of the image capture device or of the display 210, configuring a wirelessly connected device, or setting other features of the display device 125 and/or devices coupled to the display device. The housing 200 includes handles 205 such that the operator of the display device 125 may securely hold the display device 125. In the present embodiment, the housing 200 includes a first handle 205a and a second handle 205b. The first handle 205a and the second handle 205b may be removable to allow for a user to hold the display device 125 with either hand. In one example, the first handle 205a is secured to the display device 125 by pins 304 which are received by holes included on a first end 308a and a second end 312a of the first handle 205a and the second handle 205b is secured to the display device 125 by pins 304 which are received by holes included on a first end 308b and a second end 312b of the second handle 205b. However, other connection types, such as friction connections, slot-type connections, magnetic connection, and/or other connection types as required for a given application are also considered. The handles 205 therefore allow the user to hold the display device 125 with one hand and control the image capture device 104 with the other hand.

The user interface 212 may include a number of inputs 214 (e.g., push buttons, soft keys, touch screen icons, etc.) configured to allow the operator to control one or more aspects of the display device 125 and/or a connected device, such as controlling the settings of the display 210, the image capture device 104, or features of other connected devices, such as the pipeline inspection device 100, a connected imaging device (see below), or other component as required for a given application. In some instances, the display 210 includes a resolution of 720 x 1280 pixels. However, in display resolutions of more than 720 x 1280 pixels or less than 720 x 1280 pixels are also contemplated as required for a given application.

With reference to FIG. 2, in some instances, the display device 125 also includes an electronic processor 215, an input/output interface 220, and a memory storage 225. In some examples, the electronic processor 215 is implemented as a microprocessor with separate memory, for example the memory storage 225. In other examples, the electronic processor 215 may be implemented as a microcontroller (with memory storage 225 on the same package). In other examples, the electronic processor 215 may be implemented using multiple processors. In addition, the electronic processor 215 may be implemented partially or entirely as, for example, a field-programmable gate array (FPGA), an applications specific integrated circuit (ASIC), and the like and the memory storage 225 may not be needed or be modified accordingly. In some examples, the memory storage 225 includes non-transitory, computer-readable memory that stores instructions that are received and executed by the electronic processor 215 to carry out methods described herein.

The memory storage 225 may include, for example, a program storage area and a data storage area. For instance, programs for processing images captured by the image capture device 104 of the pipeline inspection device 100 may be stored in the memory storage 225. The memory storage 225 may include embedded multimedia card (eMMc) memory for storing associated programs/firmware, etc. However, other memory types are also contemplated as required for a given application. In some instances, the captured and processed images may be saved to another location or device, such as on a Micro SD card or other memory storage devices required for a given application. The program storage area and the data storage area may include combinations of different types of memory, for example read-only memory and random-access memory. The input/output interface 220 may include one or more input mechanisms and one or more output mechanisms (for example, general-purpose input/outputs (GPIOs), a network bus interface, analog inputs, digital inputs, Universal Serial Bus (“USB”) and others as required for a given application). The display device 125 includes a connection port 230 for electrically and mechanically interfacing with a connector 235 of the cable 135 to the display device 125. The connection port 230 may be, for example, a 6-pin keyed round connector. The connector 235 may be an associated 6-pin keyed round connector configured to interface with the connection port 230. However, other connection port and associated connector types are contemplated as required for a given application. The display device 125 also includes rechargeable battery pack 130 as previously described.

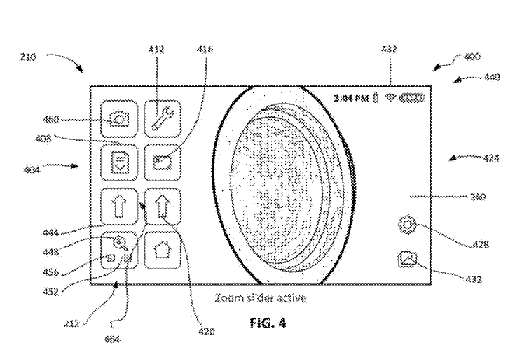

Referring to FIG. 4, the display 210 includes a home screen 400 which has the user interface 212 overlaid over the image or video 240 captured by the image capture device 104. The user interface 212 includes several touchscreen icons on a first side 404 of the display 210. The icons include a variable slider 408, a camera icon 412, a video icon 416, and a camera view icon 420. The user interface 212 further includes several touchscreen icons on a second side 424 of the display 210. The icons include a settings icon 428 and a gallery icon 432. Lastly, the user interface 212 includes the time and a battery status icon 436 on a top corner 440. Each icon has an opacity of about 15% such that the image is visible behind the user interface 212. However, opacity values of more than 15% or less than 15% are also contemplated as required for a given application.

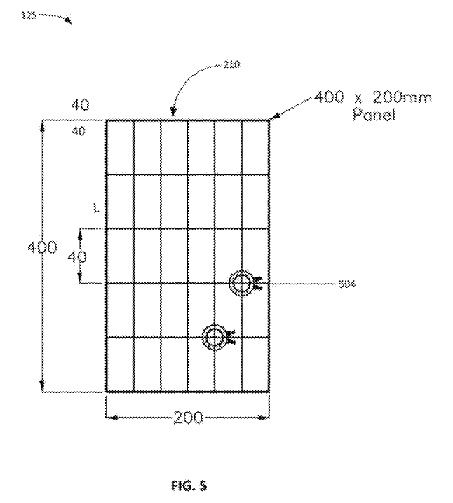

As shown in FIGS. 3 and 5, the display device 125 is configured to provide haptic feedback in response to the user interacting with the display 210. Accordingly, the display device 125 further includes a haptic feedback device 504 which is attached to the display device 125 and is configured to provide haptic feedback to the user. In the present embodiment, the haptic feedback device 504 is positioned within the housing 200 of the display device 125 spaced a distance L from the display 210. More particularly, the distance L may be any amount from 0 millimeters (mm) to 400 mm from the display 210. In the present embodiment the distance L is 240 mm. In other words, the haptic feedback device 504 is spaced 240 mm from the display 210. In the present embodiment, the haptic feedback device 504 is an exciter mounted near a backside of the display 210. The exciter is configured to play low frequency tones through in-built speakers to induce vibration in the display 210 during touch screen interactions. In other words, in response to the user pressing a touch screen icon, the exciter will provide touch sensations (vibration, air pressure, resistance, heat, etc.) to simulate physical experiences. The exciter is configured to output different frequencies, frequency patterns, and durations in response to different touch screen interactions. For example, the exciter may output a first frequency in response to the user pressing the video icon 416 and a second frequency in response to the user pressing the camera icon 412 to distinguish between the two icons. In some embodiments, the display device 125 may not include a traditional speaker. Accordingly, the exciter may be configured to play, or output, audio files in lieu of the traditional speaker.

In other embodiments, instead of an exciter, the haptic feedback device 504 may be a haptic transducer implemented to induce vibrations in the display device 125. In such embodiments, the haptic transducer may be mounted to the backside of the display 210. Similar to the exciter, the haptic transducer is configured to output different frequencies, frequency patterns, and durations in response to different touch screen interactions. Accordingly, including a haptic feedback device 504 in the display device 125 advantageously enables the user to have touch-based, intuitive interactions with the display device 125, especially when the user is wearing gloves.

Alternatively, or additionally to the display device 125, the user may use a cellular device to view the images or videos captures by the image capture device 104. For example, the user may download an app to view the images or videos captures by the image capture device 104. In the present embodiment, the user interface 212 remains the same regardless of whether the user is using the display device 125 or the cellular device. The user interface 212 is configured to be compatible with iOS and Android to maintain a consistent user experience.

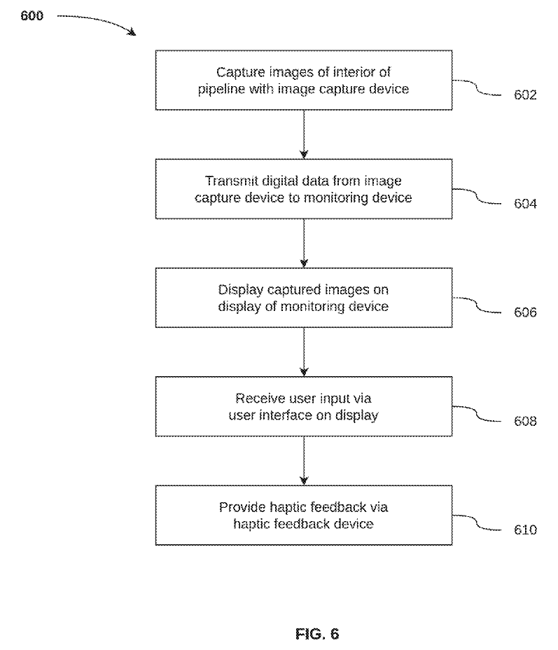

FIG. 6 illustrates a process 600 of inspecting a pipeline, according to some aspects and examples. The process 600 includes capturing images of an interior of the pipeline with the image capture device 104 positioned at a distal end of the push cable 102 (step 602). The process 600 further includes transmitting digital data corresponding to the captured images from the image capture device 104 to the display device 125 (step 604). The process 600 further includes displaying the captured images on the display 210 of the display device 125 (step 606). The process 600 further includes receiving user input via the user interface 212 on the display 210 (step 608). In some examples, the user input may include the user pressing a touchscreen icon, such as the camera icon 412, the video icon 416, or other icons of the user interface 212. The process 600 further includes providing haptic feedback via the haptic feedback device 504 in response to the user input (step 610). In some examples, providing haptic feedback includes inducing vibration in the display 210 via the exciter. In some examples, the haptic feedback device 504 may output different frequencies, frequency patterns, and durations in response to different user inputs to distinguish between different touchscreen interactions.

In some examples, the process 600 may further include adjusting a setting of the image capture device 104 in response to the user input received via the user interface 212. For instance, the user may adjust brightness, contrast, zoom level, or other image capture parameters by interacting with the variable slider 408 or other icons on the user interface 212. The haptic feedback provided in response to such adjustments may vary in intensity or pattern to indicate the magnitude of the adjustment being made. Additionally, the process 600 may include saving the captured images or video to the memory storage 225 of the display device 125 or to an external storage device, such as a Micro SD card, in response to the user pressing the camera icon 412 or the video icon 416.

In some examples, the process 600 may also include wirelessly transmitting the digital data from the image capture device 104 to the display device 125 via a near field communication (NFC) connection, a short-range wireless connection (for example, a Bluetooth® connection), an IEEE 802.11 protocol connection (for example, Wi-Fi), or the like. In such examples, the display device 125 may receive the digital data without requiring a physical cable connection to the pipeline inspection device 100. The process 600 may further include generating a report based on the captured images, where the report includes annotations or markers added by the user via the user interface 212. The first marker icon 460 and the second marker icon 464 may be used to identify specific locations or defects within the pipeline for documentation purposes.

Accordingly, various implementations of the systems and methods described herein provide, among other things, a system of pipeline inspection. Other features and advantages of the invention are set forth in the following claims.

In the foregoing specification, specific examples have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

An element proceeded by “comprises …a,” “has …a,” “includes …a,” or “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

1. An inspection system, the system comprising:
a cable including an image capture device positioned at a distal end of the cable, wherein the image capture device is configured to output digital data; and
a monitoring device configured to receive the digital data from the image capture device, the monitoring device including:
a housing including a removable first handle and a removable second handle;
a display supported by the housing and configured to display images captured by the image capture device in response to receiving the digital data;
a user interface on the display; and
a haptic feedback device configured to provide haptic feedback in response to a user interaction with the user interface.

2. The inspection system of claim 1, wherein the haptic feedback device is an exciter configured to induce vibration in the display during touchscreen interactions.

3. The inspection system of claim 2, wherein the exciter is configured to output different frequencies in response to different touchscreen interactions.

4. The inspection system of claim 1, wherein the haptic feedback device is a haptic transducer mounted to a backside of the display.

5. The inspection system of claim 1, wherein the user interface includes a plurality of touchscreen icons, each touchscreen icon having an opacity that permits an underlying image to remain visible behind the user interface.

6. 6. The inspection system of claim 5, wherein the plurality of touchscreen icons includes a variable slider, a camera icon, a video icon, a camera view icon, a settings icon, a gallery icon, and a battery status icon.

7. The inspection system of claim 1, wherein the removable first handle and the removable second handle are each secured to the housing by pins received by holes at a first end and a second end of each respective handle.

8. The inspection system of claim 1, wherein the monitoring device further includes a connection port configured to electrically and mechanically interface with a connector of a cable.

9. The inspection system of claim 1, wherein the monitoring device further includes an electronic processor, an input/output interface, and a memory storage configured to store instructions executable by the electronic processor.

10. The inspection system of claim 1, wherein the image capture device includes a removable cover configured to protect the image capture device.

11. A display device for use with a pipeline inspection system, the display device comprising:
a housing including a removable first handle and a removable second handle;
a display supported by the housing and configured to display images captured by an image capture device of the pipeline inspection system;
a user interface on the display; and
a haptic feedback device positioned within the housing and spaced a distance from the display, the haptic feedback device configured to provide haptic feedback in response to a user interaction with the user interface.

12. The display device of claim 11, wherein the distance is from 0 millimeters to 400 millimeters from the display.

13. The display device of claim 11, wherein the haptic feedback device is configured to output different frequencies, frequency patterns, and durations in response to different touchscreen interactions with the user interface.

14. The display device of claim 11, wherein the display device is configured to connect to the pipeline inspection system via a cable including a USB-C connector.

15. The display device of claim 11, further comprising a detachable, rechargeable battery pack attached to the display device.

16. A method of inspecting a pipeline, the method comprising:
capturing images of an interior of the pipeline with an image capture device positioned at a distal end of a cable;
transmitting digital data corresponding to the captured images from the image capture device to a monitoring device;
displaying the captured images on a display of the monitoring device;
receiving user input via a user interface on the display; and
providing haptic feedback via a haptic feedback device in response to the user input.

17. The method of claim 16, wherein providing haptic feedback includes inducing vibration in the display via an exciter.

18. The method of claim 17, wherein providing haptic feedback further includes outputting different frequencies in response to different user inputs.

19. The method of claim 16, further comprising displaying the user interface overlaid on the captured images, wherein the user interface includes a plurality of icons each having an opacity that permits the captured images to remain visible behind the user interface.

20. The method of claim 16, further comprising holding the monitoring device via a removable first handle and a removable second handle on a housing of the monitoring device.
